(19) United States
(12) Patent Application Publication
(10) Pub. No.: US 2025/0058262 A1
(43) Pub. Date: Feb. 20, 2025

(54) AIR FILTER WITH SIDE FRAME PIECES REMOVABLY NESTABLE ONTO END FRAME PIECES

(71) Applicant: 3M INNOVATIVE PROPERTIES COMPANY, St.Paul, MN (US)

(72) Inventors: MICHAEL L. MUNSON, Maple Grove, MN (US); Samir Lakha, Champlin, MN (US); Dennis M. Glass, Cottage Grove, MN (US)

(21) Appl. No.: 18/721,615

(22) PCT Filed: Dec. 14, 2022
(86) PCT No.: PCT/IB2022/062250

§ 371 Date: Jun. 18, 2024

Related U.S. Application Data
(60) Provisional application No. 63/292,623, filed on Dec. 22, 2021.

(51) Int. Cl. B01D 46/42; B01D 46/00; B01D 46/52

(52) U.S. Cl. CPC B01D 46/4227; B01D 46/0005; B01D 46/0016; B01D 46/521; B01D 2271/02; B01D 2275/203

(57) ABSTRACT

An air filter with an expandable pleated air filter media assembly and with first and second end frame pieces permanently attached to first and second ends of the pleated air filter media assembly; and, with first and second side frame pieces that are removably nested onto the first and second end frame pieces. The first and second side frame pieces can be removed from their nested positions on the first and second end frame pieces and mounted on first and second corrugated edges of the pleated air filter media assembly, whereupon the first and second side frame pieces, and the first and second end frame pieces, collectively form a perimeter support frame.

### BACKGROUND

Air filters are commonly used in forced air systems, e.g. residential and commercial heating and air-conditioning (HVAC) systems, in order to remove dust and dirt particles and the like. Conventional air filters have permanent rigid frames that dictate that the air filter must exhibit its end-use size when shipped to a retailer, when presented to potential purchasers, and when stored by an end user. Consequently, these air filters undesirably occupy a relatively large volume of space on transportation vehicles, on retailer shelves, and in end user's homes.

### SUMMARY

Herein are disclosed air filters and methods of making and using. The air filters may comprise an expandable pleated air filter media assembly and with first and second end frame pieces permanently attached to first and second ends of the pleated air filter media assembly and with first and second side frame pieces that are removably nestable onto the first and second end frame pieces. The first and second side frame pieces can be removed from their nested positions on the first and second end frame pieces and mounted on first and second corrugated edges of the pleated air filter media assembly, whereupon the side frame pieces and the end frame pieces collectively form a perimeter support frame. These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a perspective view of an exemplary air filter as disclosed herein, arranged in a collapsed state.

FIG. 2 is a perspective view of the air filter of FIG. 1 in the process of being transitioned from the collapsed state to an expanded state.

FIG. 3 is a perspective view of the air filter of FIG. 1 in an expanded state, with side frame pieces in place on corrugated edges of the pleated media so that the air filter is a framed air filter.

FIG. 4 is a perspective view of another exemplary air filter, arranged in a collapsed state.

FIGS. 5 and 6 are perspective views of the air filter of FIG. 4 in the process of being transitioned to an expanded state.

FIG. 7 is a perspective view of the air filter of FIG. 4 in an expanded state, with side frame pieces in place on corrugated edges of the pleated media so that the air filter is a framed air filter.

FIG. 8 is a front view of the air filter of FIG. 4, arranged in a collapsed state.

Like reference numbers in the various figures indicate like elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

Although terms such as “top”, bottom ”, “upper”, lower ”, “under”, “over”, “front”, “back”, “up” and “down”, and “first” and “second” may be used in this disclosure, it should be understood that those terms are used in their relative sense only unless otherwise noted. Terms such as “outer”, “outward”, “outwardmost”, “outwardly”, and the like, refer to a direction generally away from the geometric center of the air filter media. Terms such as “inner”, “inward”, “inwardmost”, “inwardly”, and the like, refer to a direction generally toward the geometric center of the air filter media. The terms “upstream” and “downstream” are used to respectively denote the near and far sides of filters as pictured e.g. in FIGS. 3 and 7. These terms are used purely for convenience in describing filters and components thereof, irrespective of how such a filter might be eventually installed into a forced air ventilation system. (Many filters may be symmetric so that they can be installed with either major side facing upstream or downstream.) The term “span” is used for describing the dimension of the air filter along an expanding/collapsing direction as discussed below, with the term “width” being used for describing the dimension of the air filter along the pleat direction as also discussed below. Terms such as “permanently” attachable, mountable, etc., mean that entities attached or mounted in this manner cannot be detached or separated from each other without unacceptable damage to at least one of the entities. The term “configured to” and like terms is at least as restrictive as the term “adapted to”, and requires actual design intention to perform the specified function rather than mere capability of performing such a function.

### DETAILED DESCRIPTION

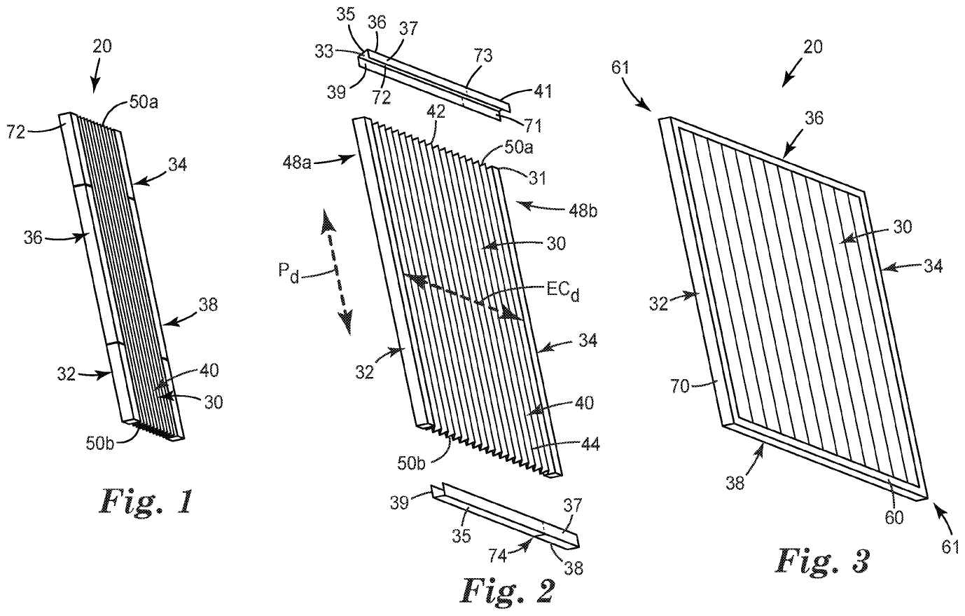

An exemplary air filter 20 in accordance with principles of the present disclosure is shown in FIGS. 1-3. The air filter 20 is configured to be expandable by a user from a collapsed, initial state (FIG. 1) to an expanded, end-use state (FIG. 3), and to be recollapsible if desired, along an expanding/collapsing direction EC_{d} as indicated in FIG. 2. The air filter 20 includes a pleated filter media assembly 30, opposing first and second end frame pieces 32, 34, and opposing first and second side frame pieces 36, 38, as seen most easily in FIGS. 2 and 3. The pleated filter media assembly 30 is configured to quickly and easily transition between collapsed and expanded states by manually moving the end frame pieces 32, 34 toward or away from each other. Upon transitioning (expanding) the pleated filter media assembly 30 to an expanded state that has a desired span (e.g., 25 inches), the side frame pieces 36, 38 are manipulated as described below to secure the pleated filter media assembly 30 in the selected expanded state. In some embodiments, a removable wrapper or other packaging can be provided to initially retain the air filter 20 in the collapsed state, and can be removed to allow expansion. The air filter 20 does not require a conventional, factory-installed rigid frame permanently surrounding the pleated filter media assembly 30, and can be initially formed in the collapsed state to save space in shipping and display.

Air filter 20 comprises a pleated filter media assembly 30. By “pleated” is meant a filtration web that has been folded into rows of generally parallel, oppositely oriented folds that provide alternating pleats and valleys on both sides of the filter media assembly. For example, and as shown in FIG. 2, the pleated filter media assembly 30 includes a plurality of pleats 40, each including a fold line 42 defining an elongate pleat tip 44, and a pair of adjacent panels. Such a structure will exhibit a pleat direction (P_{d}, indicated in FIG. 2, that is parallel to the elongate pleat tips and is generally orthogonal to the expanding/collapsing direction EC_{d}. Various parameters of the pleated media (e.g. pleat spacing. pleat height, and so on) can be chosen as desired; typically such parameters will be chosen for the pleated filter media in its expanded, in-use configuration. The pleated structure allows the filter media to be “accordionized” into a collapsed configuration in which the pleat tips (and pleat panels) are crowded quite close together or even in contact with each other, and then expanded into the in-use configuration at the desired time.

At least when expanded into an expanded configuration, the pleated filter media assembly 30 can have a rectangular shape (which includes square shapes) as shown e.g. in FIG. 3, defining opposing ends 48a, 48b and opposing edges 50a. 50b. For clarity of description, items 48 will be referred to herein as the “ends” of the pleated filter media assembly 30; items 50 will be referred to as the “corrugated edges” of the pleated filter media assembly 30. With the expanded pleated filter media assembly 30 and other components in their end-use configuration, the above-mentioned opposing first and second end frame pieces 32 and 34 will be present on the ends 48a, 48b of the pleated filter media assembly 30. and the above-mentioned first and second side frame pieces 36 and 38 will be present on the corrugated edges 50a, 50b, of the pleated filter media assembly 30, so as to collectively provide a perimeter frame 60 as indicated in FIG. 3.

The pleated filter media assembly 30 can be expanded at least once from a collapsed condition (as in FIG. 1) to an expanded condition (as in FIGS. 2 and 3). In some embodiments, the assembly can be repeatedly transitioned back and forth between an expanded condition as in FIG. 3 and a collapsed condition as in FIG. 1. However, in some embodiments the assembly may only need to be expandable from a collapsed condition to a desired expanded condition (e.g., an expanded condition in which the assembly has a span that matches the dimension of a filter receptacle of an HVAC system). In some such embodiments, the assembly may not necessarily need to be collapsible fully back to the original collapsed condition. Rather, in some such embodiments the assembly need only be collapsible to an extent to correct an inadvertent over-expansion past the desired expanded condition as discussed later.

It is noted that the “expanded” condition of the pleated filter media assembly 30 as an individual component generally corresponds with the “expanded” state of the air filter 20 (FIG. 3) as a whole (and the “collapsed” condition of the pleated filter media assembly 30 similarly corresponds with the “collapsed” state of the air filter 20 (FIG. 1)), except that the air filter 20 includes additional components (as described herein) that can retain the pleated filter media assembly 30 in the particular size and shape of the expanded condition. In other words, while the pleated filter media assembly 30 may be transitioned to any of a number of different “expanded conditions” and “collapsed conditions”, the pleated filter media assembly 30 cannot, in and of itself, self-retain the shape of any one particular condition. The air filter 20, however, as a whole (with first and second side frame pieces installed along the corrugated edges as described herein) can self-retain the shape of a selected expanded state.

Pleated air filter media assembly 30 may comprise any suitable air filter media. The air filter media is typically sheet-like, with (with the air filter in an expanded condition) a span along the expanding/collapsing direction, and a width along the pleat direction, that are considerably greater than the thickness of the air filter media. Any suitable pleated air filter media may be used. In some embodiments, filter media may be, or include, a nonwoven material. In some embodiments, filter media may comprise fiberglass fibers. Nonwoven webs which may be used as, or as a layer, of, the filter media can be a high loft spunbond web, such as described, for example, in U.S. Pat. No. 8,162,153. In some embodiments, the filter media can be, or include, a low loft spunbond web, such as those described in U.S. Pat. No. 7,947,142. In some embodiments, an electrostatic charge is optionally imparted into or on to material(s) of the filter media. Thus, the filter media can be an electret nonwoven web. Electric charge can be imparted to the filter media in a variety of ways as is well known in the art, for example by hydrocharging, corona charging, etc. (e.g. as described in U.S. Pat. No. 7,947,142). In other embodiments, the filter media is not electrostatically charged. Pleats can be formed in the filter media using various methods and components as are well known in the art, for example those described in U.S. Pat. Nos. 6,740,137 and 7,622,063.

In some embodiments, the filter media may include one or more reinforcing layer or entities comprising e.g. an open cell structure, a porous media, a nonwoven scrim, a netting, a wire mesh, or any such structure(s), which may be provided along with (e.g., bonded to) a layer that performs the actual filtration and which may be made of any suitable material. Such an entity may be e.g. bonded only to the pleat tips of the pleated media; or, it may be bonded to a major surface of the media and then pleated along with the media so as to be in contact with the panels of the pleats as well as with the pleat tips. In some embodiments, the pleated filter media assembly 30 may comprise reinforcing entities in the form of a set of extruded reinforcing filaments of the general type described in U.S. Patent Application Publications 2021/0229022 and 2021/0229023, both of which are incorporated by reference in their entirety herein. Whether inherently, or as assisted by reinforcing entities (e.g. set of extruded filaments, or a wire mesh) that are bonded at least to the pleat tips, the filter media will be sufficiently strong to survive the air pressure applied in conventional forced-air heating and/or cooling systems.

Returning to FIGS. 1-3, the first and second end frame pieces 32, 34 are respectively mounted to ends 48a, 48b of the pleated filter media assembly (in the factory), and remain permanently attached to ends 48a, 48b during the manipulations described herein and during use of the air filter 20. In some embodiments, end frame pieces 32, 34 can be identical or substantially identical to each other. During manipulation (e.g. expansion) of the pleated air filter media assembly 30, the end frame pieces 32, 34 can serve as handles, facilitating user grasping and manipulation of the pleated filter media assembly. During use of the air filter 20 for filtration, the end frame pieces 32, 34 will serve as opposing portions of the frame 60 that supports the air filter. The end frame pieces 32, 34 will also occlusively cover the ends 48a, 48b of the pleated filter media assembly 30 so as to prevent or minimize any leakage of air around the ends 48a, 48b of the pleated air filter media assembly during use. The end frame pieces 32, 34 can be permanently attached to the pleated filter media assembly 30 (e.g., to ends 48a, 48b thereof) in various manners as known in the art and as appropriate for the materials employed. For example, in some embodiments, the end frame pieces 32, 34 may be adhesively bonded over a corresponding one of the ends 48a, 48b of the pleated filter media assembly 30. As an alternative, or in addition, to such arrangements, the ends of the pleated filter media assembly 30 may be mechanically attached to the end frame pieces, e.g. by stapling.

In various embodiments, the end frame pieces 32, 34 may be constructed of materials commonly used for HVAC filter frames, such as paper, paperboard, plastic, metal, etc. The end frame pieces 32, 34 will typically have an elongate length that generally corresponds with the “width” (along the pleat direction P_{d}) of the pleated filter media assembly 30, as evident from FIGS. 2 and 3. The length of the end frame pieces 32, 34 will thus correspond to the “width” of the air filter 20 in use, and will also correspond to the “width” of the air filter when in a collapsed configuration as in FIG. 1. In some embodiments, these values are fixed; thus, in such embodiments, the air filter 20 will have a fixed “width” (of any suitable value, e.g. 25 inches) but may be expandable to a range of “spans”, e.g. 16, 20, or 25 inches.

The side frame pieces 36, 38 can assume a variety of forms, and in some embodiments may be substantially identical. In many embodiments, the length of each side frame piece 36, 38 will be no greater than, and often will be less than, the length of each end frame piece 32, 34. As disclosed herein, with pleated filter media assembly 30 in a collapsed configuration (e.g. as delivered to an end-user), each side frame piece 36, 38 will be removably nested onto an end frame piece 32, 34 in the general manner shown in FIG. 1. By nested is meant that a side frame piece is mounted onto the outward side of an end frame piece, with the side frame piece fitting snugly onto the end frame piece so that much or all of an imaginary volume defined by the side frame piece will be occupied by portions of the end frame piece (and possibly by portions of the filter media assembly), as will be appreciated from examination of the nested arrangements depicted in FIGS. 1, 4 and 8.

Each side frame piece can be completely removed from its nested position on an end frame piece so that the side frame piece is no longer in contact with the end frame piece (this may occur before or after the pleated filter media assembly is expanded toward an expanded configuration). The pleated filter media assembly can then be manipulated into the desired expanded configuration (if this has not already been done), after which the side frame pieces are mounted onto the corrugated edges 50a, 50b of the pleated filter media assembly as indicated in FIG. 2. The side frame pieces may then be secured in place so that the side frame pieces and end frame pieces collectively provide a perimeter support frame 60 as shown in FIG. 3. The resulting air filter 20 is then ready for installation into an air-handling system.

It will be appreciated that a side frame piece that is completely removable from an end frame piece as described above, i.e. so that no portion of the side frame piece is in contact with the end frame piece, is distinguished from a side frame piece that is e.g. hingedly connected to an end frame piece. Similarly, side frame pieces that are configured to be nestable on end frame pieces as disclosed herein are distinguished from side frame pieces that are not configured to be nestable on end frame pieces.

In many embodiments, end frame pieces 32, 34, and side frame pieces 36, 38, may be generally U-shaped e.g. as depicted in FIG. 2. The resulting framed air filter will thus be the type of air filter generally referred to as a channel-framed filter. In such embodiments, a side frame piece may exhibit an outer sidewall 35, and upstream and downstream flanges 37 and 39 that each extend inwardly (toward the geometric center of the framed air filter) therefrom, again as evident in FIG. 2. The width of the outer sidewall 35 will typically correspond to the upstream-downstream dimension of the resulting framed air filter (e.g. an outer sidewall that is approximately one inch in width will correspond to a nominally one-inch framed filter, e.g. in the case of a 25″×16″×1″ framed filter). Thus, the “width” of an outer sidewall 35 specifically means the dimension of the outer sidewall along the upstream-downstream direction of the air filter, and does not correspond to the previously-defined “width” of the pleated air filter media assembly and air filter.

End frame pieces 32, 34 may exhibit a similar structure, which facilitates the desired nestability. with at least portions of the upstream and downstream flanges of the side frame pieces respectively overlapping at least portions of the upstream and downstream flanges of the end frame pieces when the side frame pieces are nested onto the end frame pieces. The overlapping will be outward along the upstream-downstream direction; i.e., the upstream flanges of the side frame pieces will be upstream of the upstream flanges of the end frame pieces and the downstream flanges of the side frame pieces will be downstream of the downstream flanges of the end frame pieces. In some embodiments, the nesting may be such that an inward surface 33 of an outer sidewall 35 of a side frame piece (or, a layer present on inward surface 33) may closely abut (e.g., within 5, 3, 2 or 1 mm), or even contact, an outer surface of an outer sidewall of an end frame piece.

In many embodiments, in a framed filter formed from such end frame pieces 32, 34 and side frame pieces 36, 38, the upstream and downstream flanges 37 and 39 of terminal portions 41 of each side frame piece 36, 38, and the upstream and downstream flanges of terminal end portions of each end frame piece, may overlap at the corners 61 of the frame, in the general manner evident from FIG. 3. Such arrangements may enhance the ability of terminal portions 41 of side frame pieces 36, 38 to be attached to terminal portions 31 of end frame pieces 32, 34 at corners 61 of frame 60, e.g. by bonding an adhesive area 71 of a flange of a side frame piece to an area of a flange of an end frame piece that it overlaps, as indicated in exemplary embodiment in FIG. 2.

The herein-disclosed manipulation of a side frame piece 36, 38 from a configuration in which it is nested onto an end frame piece 32, 34, into a configuration in which it is mounted on a corrugated edge 50a, 50b of the pleated filter media assembly 30 to become a portion of a perimeter frame 60, does not require the side frame piece to be “inverted” in order to accomplish this. That is, it is not required that the upstream and downstream flanges 37 and 39 of the side frame piece be rotated 180 degrees from their original configuration (as nested on an end frame piece) in order to be mounted on a corrugated edge. It will be appreciated that this can advantageously allow the side frame pieces to be as rigid as needed to provide the necessary strength of the resulting perimeter frame 60.

The side frame pieces may be secured in place in the finished frame 60 by any desired mechanism or combination thereof. These include adhesive methods (as mentioned above), and mechanical fastening methods. In some embodiments this may be done at least in part by attaching terminal portions of the side frame pieces to terminal portions of end frame pieces where they come into close proximity, at the corners of the framed air filter. For example, parcels of pressure-sensitive adhesive may be disposed on the inward surface of areas of upstream and/or downstream flanges of terminal portions of a side frame piece in the general manner noted above. After the side frame pieces are fitted onto the corrugated edges of the filter media assembly, these areas of the flanges of the side frame pieces may be adhesively bonded to areas of the upstream and downstream flanges of terminal portions of end frame pieces with which they overlap. In some embodiments, if such adhesives are present, they may be covered by release liner to ensure that the side frame pieces do not become attached to the end frame pieces during the time (before formation of the frame) that they are nestably installed thereon as in FIG. 1.

Similar arrangements may be done using mechanical fasteners rather than adhesives. Such an approach may use e.g. so-called hook and loop fasteners. For example, designated areas of upstream and downstream flanges of side frame pieces may comprise patches of loop material, with similar areas of end frame pieces comprising patches of hook material (or vice versa). Other types of mechanical fastening systems (e.g. the products available from 3M Company under the trade designation DUAL-LOCK) may be used.

In some embodiments, side frame pieces and/or end frame pieces may have any suitable tab. slot, or combination thereof, that may enhance the attachment of the pieces to each other at the corners of the framed air filter. Such approaches may be as simple as providing a terminal end of a frame piece with a tab that can be folded/wrapped around a terminal end of a neighboring frame piece at a corner. and then bonded to a surface (inward or outward) of that neighboring frame piece. Or, more complex approaches may be used in which the frame pieces comprise e.g. a set of tabs and slots that mate and/or interlock with each other. Engagement features, such as pins, teeth, hooks, etc., may be advantageously incorporated into the frame pieces to provide or promote the desired attachment of the frame pieces to each other. The surfaces of upstream and/or downstream flanges of side frame pieces and/or end frame pieces may be provided with high-friction layers or the like that enhance the interaction between the flanges of the end frame pieces and the side frame pieces. Apertures can be provided in the flanges, so that an aperture in a flange of a side frame piece can be aligned with an aperture in an end frame piece, and a fastener (in the general style of a manually-operable “rivet”) inserted therethrough. Any such feature or arrangement or combination thereof may be used; all that is necessary is that any such feature or arrangement does not prevent the side frame pieces from being nested onto the end frame pieces in the manner discussed herein.

In some embodiments, the attachment of terminal portions of the side frame pieces to terminal portions of the end frame pieces may be permanent, e.g. if the side frame pieces are only to be used one time. However, in some embodiments, side frame pieces may be reusable, meaning that they can be removed from a spent air filter 20 and then installed onto a new pleated filter media assembly 30 to form a perimeter frame of a new air filter 20. (Thus in some embodiments, replacement filter media assemblies 30 may be supplied to end users, without including any side frame pieces 36, 38 therewith). In such a case, any method of attaching the terminal portions of the side frame pieces to the terminal portions of the end frame pieces will be detachable so that the side frame pieces can be removed at the desired time. It will be appreciated that many mechanical fastening systems (such as e.g. hook-and-loop, and even some adhesive systems (e.g. that rely on pressure-sensitive adhesives that are repositionable) can allow such an arrangement.

The above discussions have primarily concerned attaching side frame pieces 36, 38 to end frame pieces 32, 34 at the corners of the pleated air filter media assembly, to form a robust perimeter frame 60 that imparts the thus-formed air filter 20 with adequate mechanical strength. In some embodiments. it may be advantageous to arrange each side frame piece so that the corrugated edge 50a of the pleated filter media assembly 30 is in intimate, occlusive contact with the inward surface 33 of the outer sidewall 35 of the side frame piece. This may minimize or prevent any air leaks around the corrugated edges of the pleated air filter media assembly. Thus for example, the inward surface 33 of the sidewall may comprise a sealing layer 72 e.g. in the form of an adhesive coating so that the corrugated edge of the pleated filter media bonds thereto upon contact with the adhesive. Or, the inward surface of the sidewall may comprise a sealing layer 72 in the form of a thin strip of resiliently compressible gasket material such as foam rubber or the like so that occlusive sealing is achieved primarily by mechanical pressure rather than by adhesive means. Any combination of such approaches may be used. Such approaches may be summarized as providing a sealing layer along some or essentially all of the elongate length of the inward surface of the outer sidewall of the side frame piece, regardless of whether the sealing layer operates by way of providing a compressible, resilient gasket, an adhesive interaction, or some combination of both. Whatever the particular arrangement, the sealing layer will be configured to be occlusively contacted by the corrugated edge of the pleated air filter media (with terms such as occlude. occlusive, occlusively, and similar terms, indicating that air leaks are minimized or prevented).

If the first and second side frame pieces are to be removable and reusable, the first and second side frame pieces may be de-mountable from the first and second corrugated edges of the pleated air filter media assembly. Or, in other embodiments, the first and second side frame pieces may be non-removably mounted onto the corrugated edges of the pleated air filter media assembly, e.g. with a sealing layer in the form of a suitable permanently-bonding adhesive.

It will be appreciated that the corrugated nature of the pleated air filter media assembly 30 will provide that the pleated media has some inherent stiffness and resistance to bowing or collapsing along the pleat direction P_{d} at the corrugated edges (in contrast to the expanding/collapsing direction EC_{d}. along which the pleated media is configured to expand and collapse very easily). This will facilitate the above sealing arrangements along the corrugated edges of the pleated media. However, if desired, the air filter media may be configured to exhibit an enhanced stiffness; or, strips of stiffening material may be applied to the air filter media along what will become the corrugated edges. Any such arrangements will allow the desired minimization of air leaks around the corrugated edges of the pleated air filter media assembly.

In various embodiments, the side frame pieces may be constructed of materials commonly used for HVAC filter frames, such as paper, paperboard, plastic, metal, etc. The material may be the same. or different, as the material used to construct the end frame pieces. The side frame pieces 36, 38 will typically have a length that substantially corresponds to, and in fact establishes. the “span” (along the expanding/collapsing direction EC_{d}) of the pleated filter media assembly end 30, as evident from FIG. 2. In some embodiments, the length of side frame pieces 36, 38 may be fixed and non-alterable. Thus in some embodiments, the pleated air filter media assembly 30 will be expanded to one particular span that is defined by the pre-selected, fixed length of side frame pieces 36, 38. For example, the side frame pieces may have a fixed length of e.g. 16 inches, 20 inches, or 25 inches.

However, in some embodiments, the length of the side frame pieces may be variable over chosen ranges (e.g. from 16 inches to 25 inches). In some embodiments this may be reversible. e.g. by making each side frame “piece” from two portions that are slidably movable relative to each other (e.g. that can “telescope” relative to each other) in a reversible manner. In other embodiments the length of a side frame piece may be a one-time choice. For example, a side frame piece could be provided at a maximum usable length (e.g. 25 inches) but may be provided with one or more friable connections 73 as shown in side frame piece 36 of FIG. 2, that allow an unneeded portion of the side frame piece to be detached from the side frame piece to leave behind a remaining side frame portion that has the desired length (e.g., 16 or 20 inches). By a friable connection is meant a connection in the form of a line of weakness that is specifically configured to easily allow complete separation (manually, e.g. by ripping with fingers) along the line of weakness. Often, such a line of weakness may be provided by a line of perforations or partial perforations. In the case of a U-shaped side frame piece, a friable connection 73 can extend through the upstream and downstream flanges 37 and 39 in addition to the outer sidewall 35, as evident for side frame piece 36 in FIG. 2. That is, the sections of the friable connection that are in the upstream and downstream flanges 37 and 39 will be aligned with the section of the friable connection that is in the outer sidewall 35. The location of a friable connection can be prechosen (e.g., at the factory) so that the remainder of the side frame piece will comprise the desired length to match/establish the desired span of the pleated filter media. Multiple friable connections may be provided so that a user may choose between desired lengths (e.g. 20 inches or 16 inches) that a side frame piece may be reduced to in order to fit into a particular receptacle of a forced-air handling system.

In a modification of this approach, a side frame piece may be provided with one or more foldable connections 74 as shown for side frame piece 38 of FIG. 2. By definition, a foldable connection of a side frame piece is a connection that is configured to allow an end portion of the side frame piece to be folded 90 degrees from a remaining portion of the side frame piece. This can provide that when the remaining portion of the side frame piece is mounted on a corrugated edge of the (expanded) pleated air filter media assembly, the end portion of the side frame piece can be “wrapped around” the adjacent end of the pleated air filter media assembly. The end portion of the side frame piece can then be nestably mounted on the end of the pleated air filter media assembly, outwardly overlapping (and e.g. attached to) a portion of an end frame piece at that end of the pleated air filter media assembly. (The foldable connection will thus be positioned at a corner 61 of the pleated air filter media assembly and perimeter frame thereof.) Such an arrangement can allow a side frame piece to be fitted to a corrugated edge of a particular length, while allowing the “extra” portion of the side frame piece to reinforce the end of the pleated air filter media assembly and to reinforce the corner between that corrugated edge and that end of the pleated air filter media assembly.

To achieve such an arrangement, a foldable connection 74 can comprise friable connections in the upstream and downstream flanges 37 and 39 (as with side frame piece 38 of FIG. 2), so that each of these flanges can be separated into sections that can partially overlap each other at the corner that is formed when the side frame piece is folded 90 degrees. The foldable connection 74 will be provided in outer sidewall 35 in the form of a line of weakness that extends across the width of the outer sidewall 35 and that is configured to allow the outer sidewall 35 to be folded 90 degrees at the line of weakness rather than to be completely torn into separate pieces. In various embodiments, such a line of weakness may be provided in outer sidewall 35 by way of imparting score lines into outer sidewall 35. In various embodiments, such a score line may be achieved e.g. by cut-scoring or crush-scoring. Such approaches (including both scoring and perforation) are described in detail in U.S. Provisional Patent Application No. 63/000,013, and in the resulting International (PCT) Patent Application published as WO 2021/191797, both of which are incorporated by reference in their entirety herein.

Numerous variations on these approaches are possible. For example, in some embodiments, a line of weakness in an outer sidewall 35 may be configured (whether e.g. by suitable scoring, or perforation) so that the outer sidewall 35 may be either folded 90 degrees, or separated, from the remaining portion of the side frame piece. This can provide the user with a choice of wrapping the “extra” end portion of the side frame piece around a corner of the frame, or removing this “extra” end portion completely.) Any such foldable connection may be at a prechosen location of a first or second frame side frame piece. Multiple foldable connections may be provided so that a user may choose between desired lengths (e.g. 20 inches or 16 inches) that a side frame piece may be reduced to in order to fit into a particular receptacle of a forced-air handling system.

In some embodiments, a pleated filter media assembly 30 may be equipped with one or more entities that, when the assembly is expanded, help to establish the desired “span” and to prevent any further expansion beyond that value. For example, such an entity could be in the form of a ribbon or strip that is attached to the end frame pieces 32, 34, and that, when the ribbon becomes extended to its maximal length, provides a “dead-stop” at a desired span. In some embodiments such an entity may be non-elastic, meaning that it exhibits an elongation at break of less than 5%. The entity could be e.g. 16, 20, or 25 inches long (when extended to its maximum length), and can be flexible so that it can be e.g. folded flat to accommodate its excess length when the pleated filter media assembly is in a collapsed condition. In some embodiments, multiple such entities may be provided (e.g. 16, 20, and 25 inches in length). Whatever the chosen span of the air filter, the corresponding length-limiting entity can be retained, while the other length-limiting entities can simply be severed and/or removed from the air filter.

In some embodiments, a pleated filter media assembly 30 may be equipped with one or more locking entities that, when the assembly is expanded to a certain point, lock the assembly into its expanded configuration so as to prevent any significant contraction back toward the original collapsed configuration. Such a locking entity may take any suitable form; in some embodiments, a locking entity may also serve as “dead-stop” entity as described above. In some embodiments, such a locking entity may be configured to prevent the pleated filter media assembly from contracting below a target value, but will not prevent contraction from a greater value back toward the target value. For example, a 20-inch locking entity may prevent any contraction below 20 inches once the assembly is expanded to or beyond a 20 inch span. However, it will not prevent, for example, reducing the span from 21 inches to 20 inches in the event that the assembly was inadvertently initially expanded too far.

An air filter 20, as manufactured, may be initially arranged in a collapsed state (FIG. 1) in which the pleated filter media assembly 30 is condensed (and held) in a compact media pack. (Strictly speaking, such an entity may not become a fully-functional air filter until it is expanded/framed as disclosed herein; however, such an entity may be referred to for convenience as an air filter.) The air filter 20 can be shipped to a retailer, stored at the retailer's place of business, displayed on the retailer's shelves, transported by a purchaser/user, and/or temporarily stored by the user in the collapsed state. At each of the stages, the air filter 20 (in the collapsed state) beneficially occupies a significantly reduced volume (as compared to the expanded state), thereby reducing associated costs and increasing user satisfaction.

When the user is ready to install the air filter 20 into a forced-air handling system (e.g. an HVAC system), the user simply removes the side frame pieces from their nested position on the end frame pieces, pulls on the two end frame pieces 32, 34 to expand the pleated filter media assembly 30 to a desired span corresponding to the size of the filter-receiving receptacle of the HVAC system, and mounts the side frame pieces on the corrugated edges of the pleated filter media. Further manipulations can be carried out to secure the terminal portions of the side frame pieces to the terminal portions of the end frame pieces, and to occlusively abut the corrugated edges of the pleated filter media against the inward surfaces of the sidewalls of the side frame pieces (e.g. against sealing layers provided thereon), if this has not occurred quasi-automatically as a result of mounting the side frame pieces on the corrugated edges.

Once the side frame pieces 36, 38 are secured to the corrugated edges of the filter media assembly with the assembly in its desired expanded state, the air filter 20 can be inserted into the HVAC system and will perform to filter contaminants from the HVAC system's airflow. In this configuration, the side frame pieces 36, 38 act in combination with the end frame pieces 32, 34 to collectively define a perimeter frame 60 that supports the pleated filter media assembly 30.

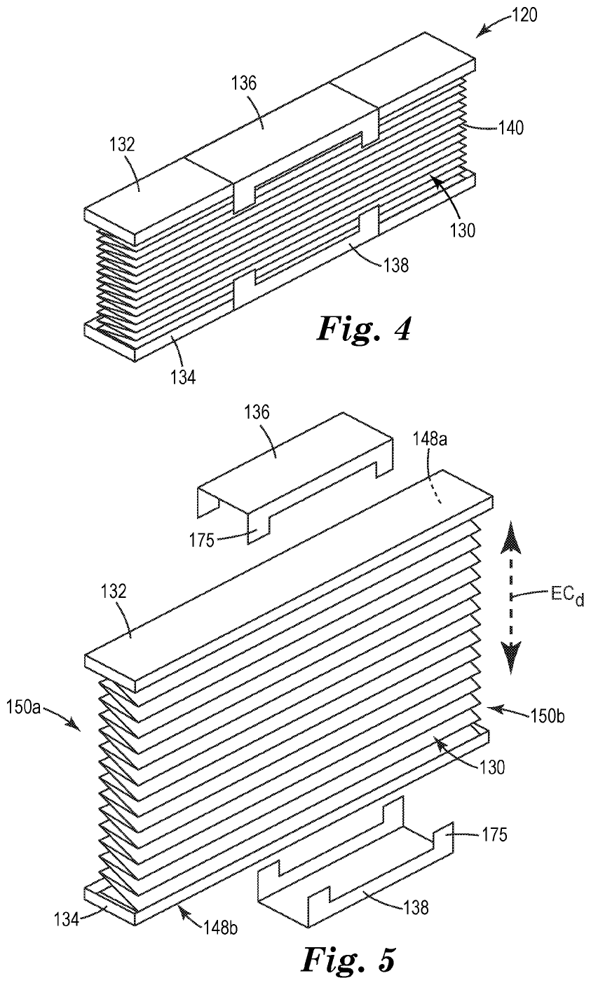

Exemplary air filter 20 as depicted in FIGS. 1-3 is of a fairly common filter design used in many residential HVAC systems. Often, such filters have a depth (which will correspond approximately to the previously-described pleat “height” plus a small amount added by the thickness of the frame) of nominally one inch. However, in some embodiments, so-called “deep-pleat” air filters may be used, with a nominal depth (and corresponding pleat height) of up to e.g. four inches. Arrangements of the general type described earlier herein, as applied to exemplary deep-pleat filters, are shown in FIGS. 4-8. Many of the features of such filters will be similar to those previously described for the filter of FIGS. 1-3; thus, in FIGS. 4-8, features that generally correspond to features already described with reference to FIGS. 1-3 will be incremented by 100. Certain features are newly introduced in FIGS. 4-8 and will be discussed below.

Thus, an exemplary “deep-pleat” air filter 120 is shown in FIGS. 4-8. As with the above-described air filter 20, air filter 120 is configured to be expandable by a user from a collapsed, initial state (FIG. 4) to an expanded, end-use state (FIG. 7), and in some embodiments to be recollapsible if desired, along an expanding/collapsing direction EC_{d} as indicated in FIG. 5. The air filter 120 includes a pleated filter media assembly 130 with pleats 140, along with opposing first and second end frame pieces 132, 134 and opposing first and second side frame pieces 136, 138. The pleated filter media assembly 130 is configured to quickly and easily transition between collapsed and expanded states by manually moving the end frame pieces 132, 134 toward or away from each other. Upon transitioning the pleated filter media assembly 30 to an expanded state that has a desired span, the side frame pieces 136, 138 are manipulated to secure and maintain the pleated filter media assembly 130 in the selected expanded state.

Pleated filter media assembly 130 will exhibit a pleat direction that is parallel to the elongate pleat tips and which is generally orthogonal to the expanding/collapsing direction EC_{d}. Various parameters of the pleated media (e.g. pleat spacing, pleat height, and so on) can be chosen as desired. with the pleat height being commensurately large in the case of a deep-pleat air filter. At least when expanded into an expanded configuration, the pleated filter media assembly 130 can have a rectangular shape with opposing ends 148a, 148b and opposing corrugated edges 150a, 150b. In the expanded air filter 120 in its end-use configuration, the opposing first and second end frame pieces 132 and 134 will be present on the ends 148a, 148b of the pleated filter media assembly 30, and the first and second side frame pieces 136 and 138 will be present on the corrugated edges 150a, 150b, of the pleated filter media assembly 130, so as to collectively provide a perimeter frame 160 as indicated in FIG. 7.

First and second end frame pieces 132, 134 are respectively mounted to ends 148a, 148b of the pleated filter media assembly (in the factory), and remain permanently attached to ends 148a, 148b during the manipulations described herein and during use of the air filter 120. During manipulation of the pleated air filter media assembly 130, the end frame pieces 132, 134 can serve as handles; during use of the air filter 120 for filtration, the end frame pieces 132, 134 will serve as opposing portions of the frame 160 that supports the air filter. The end frame pieces 132, 134 will also occlusively cover the ends 148a, 148b of the pleated filter media assembly 130 so as to prevent or minimize any leakage of air around the ends 148a, 148b of the pleated air filter media assembly during use. The end frame pieces 132, 134 can be permanently attached to the pleated filter media assembly 130 (e.g., to ends 148a, 148b thereof) in various manners as known in the art and as appropriate for the materials employed.

In various embodiments, the end frame pieces 132, 134 may be constructed of materials commonly used for HVAC filter frames, such as paper, paperboard, plastic, metal, etc. The end frame pieces 132, 134 will typically have a length that substantially corresponds with the “width” (along the pleat direction) of the pleated filter media assembly end 130. The length of the end frame pieces 132, 134 will thus correspond to the “width” of the air filter 120, in use, and will also correspond to the width of the air filter when in a collapsed configuration as in FIG. 4. In some embodiments, these values are fixed; thus, in such embodiments, the air filter 120 will have a fixed “width” (of any suitable value, e.g. 25 inches) but may be expandable/collapsible over a range of “spans”.

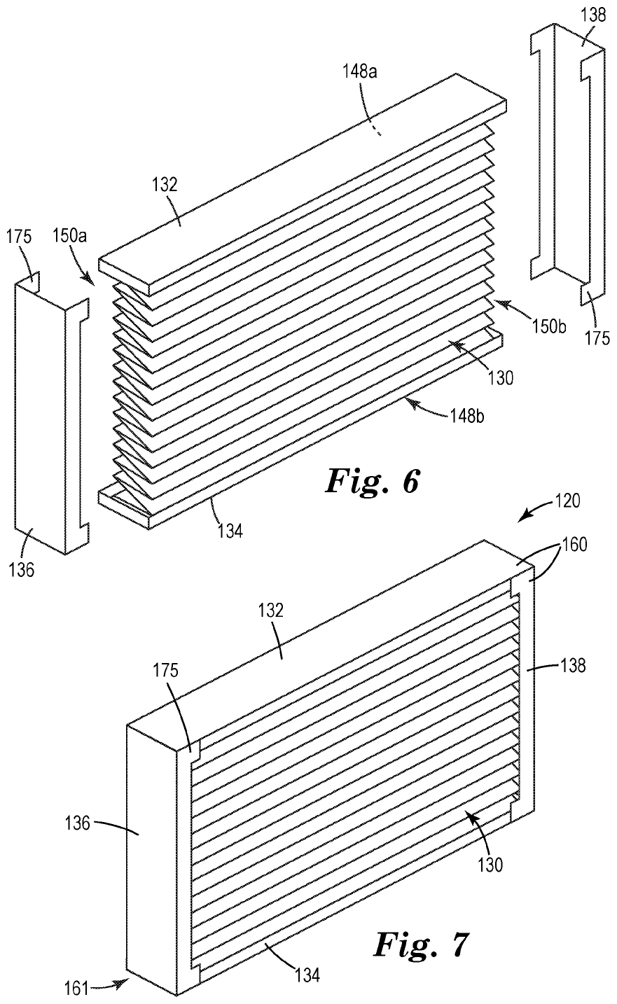

The side frame pieces 136, 138 can assume a variety of forms, and in some embodiments are substantially identical. With pleated filter media assembly 130 in a collapsed configuration (e.g. as delivered to an end-user), each side frame piece 136, 138 will be nested onto an end frame piece 132, 134 in the general manner shown in FIG. 4. Each side frame piece can then be removed from its nested position on an end frame piece (as indicated in FIG. 5); the pleated filter media assembly can then be manipulated into the desired expanded configuration (if this has not already been done), after which the side frame pieces are installed onto the corrugated edges 150a, 150b of the pleated filter media assembly as indicated in FIG. 6. The side frame pieces may then be secured in place so that the side frame pieces and end frame pieces collectively provide a perimeter support frame 160 as shown in FIG. 7. The resulting air filter 120 is then ready for installation into an air-handling system.

In many embodiments, end frame pieces 132, 134, and side frame pieces 136, 138, may all be generally U-shaped e.g. as depicted in FIGS. 5 and 6. The resulting framed air filter will thus resemble the type of air filter generally referred to as a channel-framed filter. In such embodiments, a side frame piece may exhibit an outer sidewall, and upstream and downstream flanges that each extend inwardly (toward the geometric center of the framed air filter) therefrom, again as evident in FIGS. 5 and 6. In many such embodiments, the upstream and downstream flanges of the terminal portions of each side frame piece, and the upstream and downstream flanges of the terminal portions of each end frame piece. may overlap at the corners of the framed filter. Such arrangements may enhance the ability of a terminal end of a side frame piece to be attached to a terminal end of an end frame piece at a corner of the frame.

The side frame pieces may be secured in place by any desired mechanism or combination thereof, including any of the methods described earlier herein. These include adhesive methods and mechanical fastening methods, the use of tabs, slots, manually insertable “rivets”, and so on. In some embodiments, the attachment of the side frame pieces to the end frame pieces may be permanent, e.g. if the side frame pieces are only to be used one time. However, in some embodiments, side frame pieces may be reusable, meaning that they can be removed from a spent air filter 120 and then installed onto a new pleated filter media assembly 130 to form a perimeter frame 160 of a new air filter 120. In some embodiments, it may be advantageous to arrange each side frame piece so that the corrugated edge 150a of the pleated filter media assembly 130 is in intimate, occlusive contact with the inward surface of the outer sidewall of the side frame piece, and/or to provide a sealing layer along the inward surface of the outer sidewall, in order to minimize or prevent any air leaks around the corrugated edges of the pleated air filter media assembly. In various embodiments, the side frame pieces are constructed of a material commonly used for HVAC filter frames, such as paper, paperboard, plastic, metal, etc. The material may be the same, or different, as the material used to construct the end frame pieces.

The side frame pieces 136, 138 will typically have a length that substantially corresponds to the “span” (along the expanding/collapsing direction EC_{d}) of the pleated filter media assembly end 130, as evident from FIG. 6. In some embodiments, the length of side frame pieces 136, 138 may be fixed and non-alterable. Thus in some embodiments, the pleated air filter media assembly 130, although being capable of being expandable to a range of spans, will be expanded to one particular span as defined by the fixed-length side frame pieces 136, 138. For example, side frame pieces may have a fixed length of e.g. 16 inches, 20 inches, or 25 inches. However, in some embodiments, the length of the side frame pieces may be variable over chosen ranges (e.g. from 16 inches to 25 inches). In some embodiments this may be reversible, e.g. by making each side frame “piece” from two portions that are slidably movable relative to each other. In other embodiments this length may be a one-time choice. For example, a side frame piece could be provided at a maximum usable length (e.g. of 25 inches) but may be provided with one or more friable connections that allow an unneeded portion of the side frame piece to be detached from the remainder of the side frame piece to leave behind a side frame portion of the desired length. One or more entities that provide a “dead stop” limit to the expansion may be provided if desired, in the general manner described earlier herein.

In similar manner as described earlier herein, when the user is ready to install the air filter 120 into an HVAC system, the user simply removes the side frame pieces from their nested position on the end frame pieces, pulls on the two end frame pieces 132, 134 to expand the pleated filter media assembly 130 to a desired span corresponding to the filter-receiving housing or receptacle of the HVAC system. and mounts the side frame pieces on the corrugated edges of the pleated filter media. Further manipulations can be carried out to secure the terminal portions of the side frame pieces to the terminal portions of the end frame pieces, and to occlusively abut the corrugated edges of the pleated filter media to the inward surfaces of the sidewalls of the side frame pieces (e.g. to abut the corrugated edges against scaling layers present on the inward surfaces of the sidewalls), if this has not occurred quasi-automatically as a result of mounting the side frame pieces on the corrugated edges. Once the side frame pieces 136, 138 are secured to the corrugated edges of the filter media assembly with the assembly in its desired expanded state, the air filter 120 can be inserted into the HVAC system and will perform to filter contaminants from the HVAC system's airflow. The side frame pieces 136, 138 will act in combination with the end frame pieces 132, 134 to collectively define a perimeter frame 160 that supports the pleated filter media assembly 130.

The above discussions reveal that the exemplary air filter 120 of FIGS. 4-8, and its various components and arrangements, are similar to those of exemplary air filter 20 of FIGS. 1-3. Air filter 120 does have certain newly presented features, e.g. upstream and downstream tabs 175 that are located at terminal portions of the side frame pieces and are most easily visible in FIGS. 5-7. Any such upstream tab will extend in an inward direction beyond an inward edge of the upstream flange of the side frame piece; similarly, any such downstream tab will extend in an inward direction beyond an inward edge of the downstream flange of the side frame piece. Any such upstream tab may be configured so that when the final framed air filter is formed, the tab will overlap a penultimate portion of the upstream flange of an end frame piece which the side frame piece meets to form a corner 161 of the perimeter support frame. Similarly, any such downstream tab may be configured to overlap a penultimate portion of the downstream flange of the end frame piece. Such arrangements are readily visible e.g. in FIG. 7. (The overlapping will be outward along the upstream-downstream direction in the general manner previously described.) Such tabs can provide further stability to the corners 161 of the thus-formed perimeter support frame 160, e.g. by providing additional areas of overlap with penultimate portions of the end frame pieces 132, 134, and/or by providing additional bonding areas for adhesive bonding. The size and aspect of any such tabs can be chosen as desired.

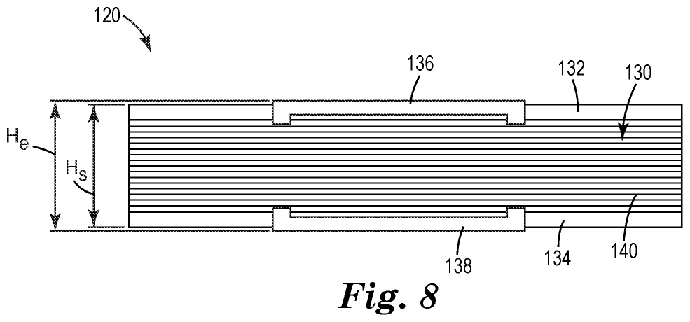

One aspect that has not been previously discussed is the quantification of the extent to which a side frame piece 136, 138 can be nestably disposed on an end frame piece 132, 134. FIG. 8 (which depicts a front view of an exemplary air filter in a collapsed condition) is provided for this purpose. When a fully collapsed air filter is viewed as in FIG. 8, a first dimension, which is the “height” as measured from the outermost surface of a first frame piece 132 to the outermost surface of a second frame piece 134, can be obtained. This height is labeled Hₑ. A second dimension, which is the “height” as measured from the outermost surface of a first nested side frame piece 136 to the outermost surface of a second nested side frame piece 138, can also be obtained. This height is labeled Hₛ, and will be slightly greater than height Hₑ, due at least to the thickness of the outer sidewalls of the two side frame pieces. In various embodiments, nesting of side frame pieces 136, 138 onto end frame pieces 132, 134 in the general manner shown in FIGS. 1, 4 and 8, may provide a nesting ratio (Hₛ/Hₑ) that is less than 1.3, 1.2, 1.1, or 1.05. (In further embodiments, the nesting ratio may be at least 1.01.) This can provide that a collapsed air filter 120 that includes side frame pieces 136, 138 nested onto end frame pieces 132, 134 thereof, may take up only a very small additional amount of space in comparison to the collapsed air filter 120 without side frame pieces 136, 138 being present.

It will be apparent to those skilled in the art that the specific exemplary embodiments, elements. structures, features, details, arrangements, configurations, etc., that are disclosed herein can be modified and/or combined in numerous ways. In summary, numerous variations and combinations are contemplated as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein but to which no priority is claimed, this specification as written will control.

What is claimed is:

1. An air filter in a collapsed configuration, the air filter comprising:
a pleated air filter media assembly that exhibits a pleat direction and is expandable along an expanding-contracting direction that is orthogonal to the pleat direction, the pleated air filter media assembly comprising first and second opposing ends and first and second opposing corrugated edges;
a first end frame piece that is permanently attached to the first end of the pleated air filter media assembly and a second end frame piece that is permanently attached to the second end of the pleated air filter media assembly; and,
a first side frame piece that is removably nested onto the first end frame piece and a second side frame piece that is removably nested onto the second end frame piece;
wherein the first side frame piece is configured to be removed from its nested position on the first end frame piece and mounted on the first corrugated edge of the pleated air filter media assembly when the pleated air filter media assembly is in an expanded configuration and wherein the second side frame piece is configured to be removed from its nested position on the second end frame piece and mounted on the second corrugated edge of the pleated air filter media assembly when the pleated air filter media assembly is in the expanded configuration,
and wherein terminal portions of the first and second side frame pieces are configured to be attached to terminal portions of the first and second end frame pieces so that the first and second side frame pieces and the first and second end frame pieces collectively form a perimeter support frame for the pleated air filter media assembly when the pleated air filter media assembly is in the expanded configuration.

2. The air filter of claim 1 wherein the first and second end frame pieces each exhibit a general U-shape when viewed along a long axis of the end frame piece, wherein the first and second side frame pieces each exhibit a general U-shape when viewed along a long axis of the side frame piece, and wherein with each side frame piece removably nested on an end frame piece, at least portions of upstream and downstream flanges of the side frame piece outwardly overlap at least portions of upstream and downstream flanges of the end frame piece, in an upstream-downstream direction.

3. The air filter of claim 1 wherein the first side frame piece comprises an outer sidewall and a sealing layer that is disposed on an inward surface of the outer sidewall and extends along at least a portion of an elongate length of the inward surface of the outer sidewall of the first side frame piece, the sealing layer being configured to be occlusively contacted by the first corrugated edge of the pleated air filter media assembly when the first side frame piece is mounted on the first corrugated edge of the pleated air filter media assembly, and,
wherein the second side frame piece comprises an outer sidewall and a sealing layer that is disposed on an inward surface of the outer sidewall and extends along at least a portion of an elongate length of the inward surface of the outer sidewall of the second side frame piece, the sealing layer being configured to be occlusively contacted by the second corrugated edge of the pleated air filter media assembly when the second side frame piece is mounted on the second corrugated edge of the pleated air filter media assembly.

4. The air filter of claim 3 wherein the sealing layers of the first and second side frame pieces each comprise a pressure-sensitive adhesive that is configured to adhesively bond to a corrugated edge of the pleated air filter media.

5. The air filter of claim 3 wherein the sealing layers of the first and second side frame pieces each comprise a resiliently compressible gasket material.

6. The air filter of claim 2 wherein at least one terminal portion of each side frame piece comprises an upstream tab that extends in an inward direction beyond an inward edge of the upstream flange of the side frame piece, and wherein the upstream tab is configured to overlap, in an upstream direction, a penultimate portion of an upstream flange of an end frame piece which the side frame piece meets to form a corner of the perimeter support frame.

7. The air filter of claim 1 wherein the first and second end frame pieces provide first and second handles whereby the pleated air filter media can be expanded from the collapsed configuration to the expanded configuration.

8. The air filter of claim 1 wherein the first and second side frame pieces each comprise at least one friable connection that is configured to allow an unneeded portion of the side frame piece to be removed from a remaining portion of the side frame piece, with the remaining portion of the side frame piece being mountable on a corrugated edge of the pleated air filter media assembly when the pleated air filter media is in the expanded configuration,
wherein the location of the friable connection is prechosen so that after the unneeded portion of the side frame piece is removed from the remaining portion of the side frame piece, an elongate length of the remaining portion of the side frame piece matches a span of the pleated air filter media assembly when the pleated air filter media assembly is in the expanded configuration.

9. The air filter of claim 7 wherein each of the first and second side frame pieces comprises at least two friable connections that are at first and second prechosen locations along the elongate length of the frame piece, each prechosen location being prechosen to provide a remaining portion of the side frame piece with an elongate length that matches a span of the pleated air filter media assembly when the pleated air filter media assembly is in a desired expanded configuration.

10. The air filter of claim 1 wherein the first and second side frame pieces each comprise at least one foldable connection that is configured to allow an end portion of the side frame piece to be folded 90 degrees relative to a remaining portion of the side frame piece so that, when the pleated air filter media is in the expanded configuration, the remaining portion of the side frame piece is mountable on a corrugated edge of the pleated air filter media assembly and the end portion is mountable on an end of the pleated air filter media assembly with the foldable connection residing at a corner of the expanded pleated air filter media assembly;
where each foldable connection is at a prechosen location of the first or second frame piece and wherein at that prechosen location, the foldable connection comprises a line of weakness that extends across the width of the outer sidewall and that allows the outer sidewall to be folded 90 degrees at the line of weakness, and wherein the foldable connection further comprises friable connections in the upstream and downstream flanges that are each aligned with the line of weakness in the outer sidewall.

11. The air filter of claim 1 wherein each of the first and second side frame pieces has a terminal portion that is configured so that an upstream flange of the terminal portion of the side frame piece is attachable to an upstream flange of a terminal portion of an end frame piece which the terminal portion of the side frame piece meets to form a corner of the perimeter support frame and/or is configured so that a downstream flange of the terminal portion of the side frame piece is attachable to a downstream flange of the terminal portion of the end frame piece which the terminal portion of the side frame piece meets to form the corner of the perimeter support frame.

12. The air filter of claim 11 wherein the terminal portions of the first and second side frame pieces are configured to be permanently attachable to the terminal portions of the first and second end frame pieces so that the first and second side frame pieces and the first and second end frame pieces collectively form a perimeter support frame for the pleated air filter media assembly when the pleated air filter media assembly is in the expanded configuration, with the first and second side frame pieces not being removable from the perimeter support frame for use in a perimeter support frame of a different pleated air filter media assembly.

13. The air filter of claim 11 wherein the terminal portions of the first and second side frame pieces are configured to be detachably attachable to the terminal portions of the first and second end frame pieces so that the first and second side frame pieces and the first and second end frame pieces collectively form a perimeter support frame for the pleated air filter media assembly when the pleated air filter media assembly is in the expanded configuration, with the first and second side frame pieces being removable from the perimeter support frame, and de-mountable from the first and second corrugated edges of the pleated air filter media assembly, so that the first and second side frame pieces can be used to form a perimeter support frame of a different pleated air filter media assembly.

14. The air filter of claim 1 wherein the air filter comprises at least one dead-stop, non-elastic entity with a first terminal end that is attached to the first end frame piece and a second terminal end that is attached to the second end frame piece and with an elongate length chosen to limit the expansion of the pleated air filter media assembly to a desired span.

15. The air filter of claim 1 wherein with the air filter in a collapsed configuration, the air filter exhibits a nesting ratio of less than 1.10.

16. A framed air filter formed from the air filter of claim 1, the framed air filter comprising the pleated air filter media assembly in the expanded configuration and having a perimeter support frame comprising the first and second side frame pieces respectively mounted on first and second corrugated edges of the pleated air filter media assembly and with terminal portions of the first and second side frame pieces attached to terminal portions of the first and second end frame pieces.

17. A method of filtering air in a powered air-handling system, the method comprising:
installing the framed air filter of claim 16 into a receptacle of a power air-handling system;
and,
allowing air to flow through the pleated filter media assembly of the framed air filter.

18. A method of expanding the air filter of claim 1 to an expanded configuration and forming a framed air filter, the method comprising:
removing the first and second side frame pieces from their nested positions on the first and second end frame pieces;
grasping the first and second end frame pieces and expanding the pleated air filter media from the collapsed configuration to a desired expanded configuration;
then,
mounting the first and second side frame pieces on the first and second corrugated edges of the pleated air filter media in the expanded configuration;
and,
attaching terminal portions of the first and second side frame pieces to terminal portions of the first and second end frame pieces to form a perimeter support frame.

19. The method of claim 18 wherein the process of mounting the first and second side frame pieces on the first and second corrugated edges of the pleated air filter media comprises bringing the first corrugated edge of the pleated air filter media into occlusive contact with a sealing layer located on an inward surface of an outer sidewall of the first side frame piece, and bringing the second corrugated edge of the pleated air filter media into occlusive contact with a sealing layer located on an inward surface of an outer sidewall of the second side frame piece.

20. A method of retrieving first and second side frame pieces from a spent framed air filter and using the first and second side frame pieces to form a frame of a new framed air filter, the method comprising:
removing the spent framed air filter from a forced-air handling system;
detaching terminal portions of the first and second side frame pieces from terminal portions of first and second end frame pieces of the spent air filter and de-mounting the first and second side frame pieces from first and second corrugated edges of the spent air filter;
expanding a new pleated air filter media assembly to a span that matches an elongate length of the first and second side frame pieces;
mounting the first side frame piece on a first corrugated edge of the new pleated air filter media assembly and mounting the second side frame piece on a second corrugated edge of the new pleated air filter media,
and
attaching terminal portions of the first and second side frame pieces to terminal portions of first and second end frame pieces that are permanently attached to first and second ends of the new pleated air filter assembly so that the first and second side frame pieces and the first and second end frame pieces collectively form a perimeter support frame for the new pleated air filter media assembly.
